(19) United States
(12) Patent Application Publication
(10) Pub. No.: US 2026/0285169 A1
(43) Pub. Date: Sep. 24, 2026

(54) ELECTRIC VEHICLE, AND CONTROLLING METHOD AND CONTROLLING DEVICE OF THE ELECTRIC VEHICLE

(71) Applicant: POU CHEN CORPORATION, Chang Hwa Hsien (TW)

(72) Inventor: Liang-Chia TSENG, Chang Hwa Hsien (TW)

(73) Assignee: POU CHEN CORPORATION, Chang Hwa Hsien (TW)

(21) Appl. No.: 19/569,173

(22) Filed: Mar. 17, 2026

(30) Foreign Application Priority Data
Mar. 18, 2025 (TW) 114110090

(51) Int. Cl. B60L 50/20; B60L 1/14; B60L 50/60; B60L 53/12; G01P 1/02; G01P 1/07; G01S 5/02; H02J 50/00; H02J 50/10

(52) U.S. Cl. CPC B60L 50/20; B60L 1/14; B60L 50/60; B60L 53/12; G01P 1/026; G01P 1/07; G01S 5/0221; G01S 5/0226; H02J 50/005; H02J 50/10; B60L 2200/12; B60L 2200/24; B60L 2240/42

(57) ABSTRACT

An electrical vehicle, a controlling method and a controlling device are provided. The controlling method is implemented using an electrical control unit and includes: a) obtaining two wireless signals from two main objects that are in proximity to the electrical vehicle; b) calculating, for each of the main objects, based on a strength of a corresponding one of the wireless signals, an instant distance between the main object and the electrical vehicle; and c) generating a controlling command that controls the electrical vehicle to implement one of the following: unlocking the electrical vehicle; locking the electrical vehicle; activating a light component of the electrical vehicle; and activating an electric machine of the electrical vehicle. By using the changes of the instant distances to control the electrical vehicle to implement different operations, the electrical vehicle can be controlled in a various, convenience and simplified manner.

### CROSS-REFERENCE TO RELATED APPLICATION

This application claims priority to Taiwanese Invention Patent Application No. 114110090, filed on Mar. 18, 2025, the entire disclosure of which is incorporated by reference herein.

### FIELD

The disclosure relates to a controlling method and a controlling device, and more particularly to an electric vehicle, and a controlling method and a controlling device of the electric vehicle.

### BACKGROUND

FIG. 1 illustrates a conventional method for controlling a status of an electric vehicle as disclosed in Taiwanese Patent No. I865995, including sensing a device 2 that supports Ultra-Wideband (UWB) by a controller 1, so as to obtain an entry of a location information of a target user. The controller 1 generates a status switch command based on the entry of the location information. The controller 1 controls an electric vehicle to, based on the status switch command, switch from an unlocked state to a locked state or switch from the locked state to the unlocked state. As such, the electric vehicle is capable of automatically unlocking based solely on the entry of the location information of the target user.

However, the conventional method for controlling a status of an electric vehicle is implemented by sensing a single device 2 (e.g., a smartphone, a wearable device, etc.) to obtain a single entry of the location information. Therefore, the technique of the status controlling method is similar to the commercially available keyless technique. In practical use, the method may only be used for switching between the unlocked state and the locked state, and the method is only different in that the object to be switched between the unlocked state and the locked state may be an electric motorcycle, an electric automobile or an electric vehicle. As such, a technical problem exists in that the usage of the method is limited.

### SUMMARY

Therefore, it is desirable to provide an electric vehicle with improved adaptability, convenience and simplicity in control, and a controlling method and a controlling device of the electric vehicle.

According to one embodiment of the disclosure, a controlling method for controlling an electric vehicle is implemented using an electrical control unit installed on the electric vehicle and including the steps of:
a) obtaining two wireless signals, each of the wireless signals being received from a main object that is in proximity to the electric vehicle and that is not a part of the electric vehicle;
b) calculating, for each of the wireless signals, a strength of the wireless signal, and for each of the main objects, calculating an instant distance between the main object and the electric vehicle based on the strength of a corresponding one of the wireless signals; and
c) generating, based on the instant distance and the relative location for each of the main objects, a controlling command that controls the electric vehicle to implement one of an operation of unlocking the electric vehicle, an operation of locking the electric vehicle, an operation of activating a light component of the electric vehicle, and an operation of activating an electric machine of the electric vehicle.

According to one embodiment of the disclosure, the controlling device for controlling an electric vehicle is electrically connected to an electrical control unit of the electric vehicle and includes two main objects and two distal communication units.

The two main objects are wearable on a human body.

The two distal communication units installed on the main objects, respectively, each of the distal communication units transmitting a wireless signal to the electrical control unit, such that the electrical control unit implements the controlling method as mentioned above.

According to one embodiment of the disclosure, the electric vehicle is controlled by a controlling device as mentioned above, and includes a vehicle frame unit, a proximal communication unit, and an electrical control unit.

The vehicle frame unit that is actuated by electrical power.

The proximal communication unit is installed on the vehicle frame unit for receiving the wireless signals.

The electrical control unit installed on the vehicle frame unit, and is electrically connected to the proximal communication unit. The electrical control unit implements the controlling method as mentioned above.

The effect of the disclosure that by detecting the instant distances of the main objects and the parts of the electric vehicle, and based on the changes of the instant distances, to control the electric vehicle to implement a number of different operations. This provides improved control of the electric vehicle 4 in regards to adaptability, convenience and simplicity.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 illustrates a conventional method for controlling a status of an electric vehicle as disclosed in Taiwanese Patent No. I865995.

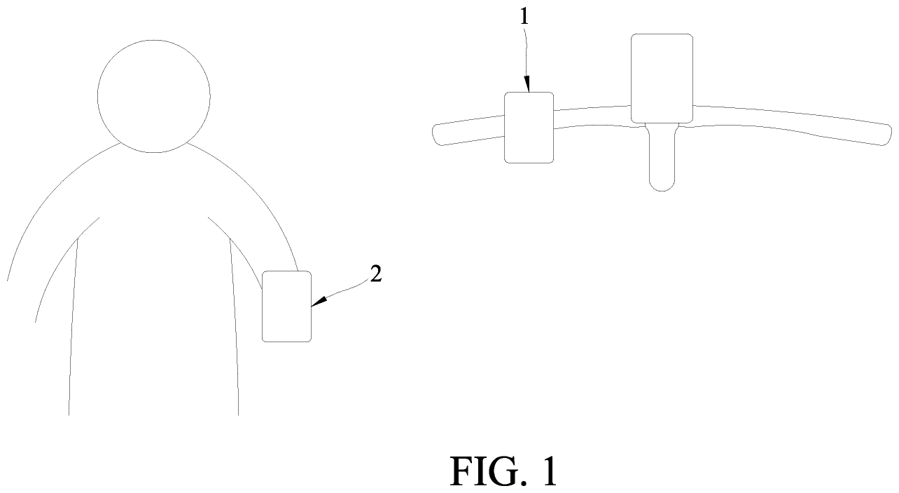

FIG. 2 is a schematic view illustrating a first embodiment of an electric vehicle and a controlling device of the electric vehicle, and showing a first mode defined by two main objects in a controlling method according to this disclosure.

FIG. 3 is a block diagram illustrating components of the electric vehicle and the controlling device of the first embodiment.

FIG. 4 is a flow chart illustrating steps of the controlling method of an embodiment of this disclosure.

FIG. 5 is a schematic view similar to FIG. 2, showing a second mode defined by the main objects.

FIG. 6 is a schematic view similar to FIG. 2, showing a third mode defined by the main objects.

FIG. 7 is a schematic view similar to FIG. 2, showing a fourth mode defined by the main objects.

FIG. 8 is schematic view similar to FIG. 2, showing the main objects being a pair of ankle bands.

FIG. 9 is a schematic view illustrating a second embodiment of an electric vehicle and a controlling device of the electric vehicle, and showing a first mode defined by two main objects in a controlling method according to this disclosure.

FIG. 10 is a block diagram illustrating components of the electric vehicle and the controlling device of the second embodiment.

FIG. 11 is a schematic view similar to FIG. 9, showing a second mode defined by the main objects.

FIG. 12 is a schematic view similar to FIG. 9, showing a third mode defined by the main objects.

FIG. 13 is a schematic view similar to FIG. 9, showing a fourth mode defined by the main objects.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

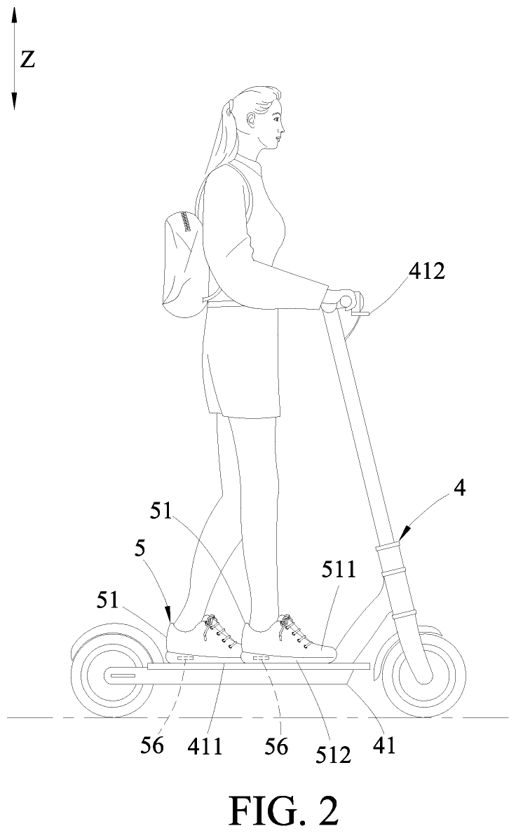

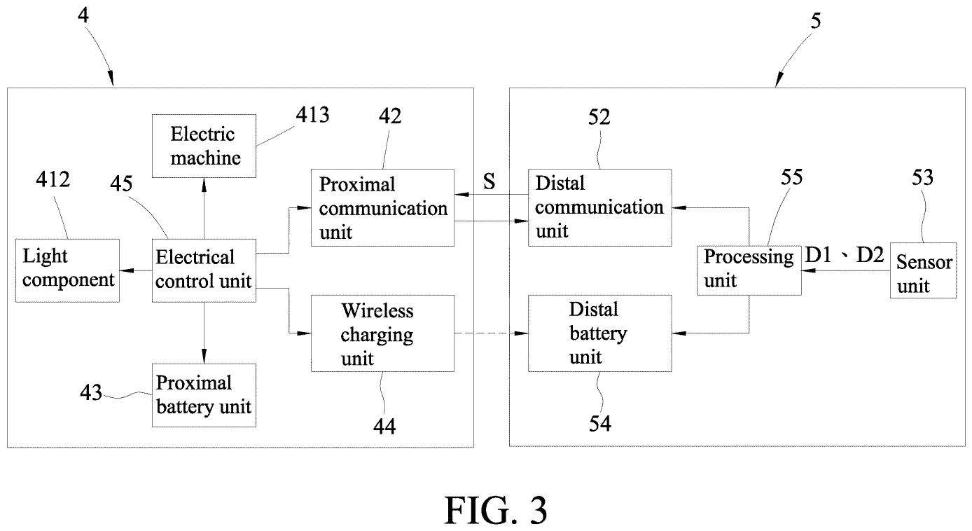

Referring to FIGS. 2 and 3, a first embodiment of an electric vehicle 4 and a controlling device 5 is provided.

In this embodiment, the electric vehicle 4 is embodied using an electric scooter, and includes a vehicle frame unit 41, a proximal communication unit 42, a proximal battery unit 43, a wireless charging unit 44, and an electrical control unit 45.

The vehicle frame unit 41 may be actuated by electrical power, and includes a force-bearing surface 411, a light component 412 that is configured to generate light for lighting, and an electric machine 413 that is capable of converting electrical power into kinetic energy.

The proximal communication unit 42 is installed on the vehicle frame unit 41, and is a short-range communication hardware module configured to communicate with the control device 5 using wireless communication techniques such as Bluetooth®, Wi-Fi, ZigBee, radio frequency ID (RFID), etc. In this embodiment, the proximal communication unit 42 is a Bluetooth® module configured to implement the Bluetooth® technique.

The proximal battery unit 43 (e.g., a rechargeable battery) is installed on the vehicle frame unit 41, and is for providing the electrical power for the light component 412, the electric machine 413, the wireless charging unit 44 and the electrical control unit 45.

The wireless charging unit 44 is installed on the vehicle frame unit 41 in proximity to the force-bearing surface 411, and is capable of transferring electrical energy to the controlling device 5 using electromagnetic induction. In use, the wireless charging unit 44 may be embodied using a hardware electrical charging unit that includes a primary coil and a secondary coil that supports charging using electromagnetic induction.

The electrical control unit 45 is installed on the vehicle frame unit 41, and is electrically connected to the light component 412, the electric machine 413, the proximal communication unit 42, the proximal battery unit 43 and the wireless charging unit 44. The electrical control unit 45 may be embodied using one or more of a central processing unit (CPU), a microprocessor, a microcontroller or other suitable hardware components.

The controlling device 5 includes two main objects 51, two distal communication unit 52, two sensor units 53, two distal battery units 54, two processing units 55, and two carrying units 56. It is noted that while the embodiment of FIG. 3 only contains one main object 51 and the corresponding components, it should be readily known by those skilled in the art that the two main objects 51 have similar structures.

The main objects 51 are wearable on the human body and are in proximity and separated from the electric vehicle 4. In this embodiment, the main objects 51 are embodied by a pair of shoes, and may be worn on the feet of a user and driven by the user's feet to move with respect to the force-bearing surface 411 of the vehicle frame unit 41. That is, the force-bearing surface 411 is configured to bear the weight of the main objects 51. Each of the main objects 51 includes a shoe vamp 511, and a sole 512 connected to the shoe vamp 511.

Each of the distal communication units 52 is a short-range communication hardware module configured to communicate with the control device 5 using wireless communication techniques such as Bluetooth®, Wi-Fi, ZigBee, radio frequency ID (RFID), etc. In this embodiment, the proximal communication unit 42 is a Bluetooth® module configured to implement the Bluetooth® technique.

Each of the sensor units 53 is for sensing acceleration and angular velocity of a corresponding one of the main objects 51 that moves with respect to the force-bearing surface 411, and to output acceleration data (D1) and angular velocity data (D2) respectively indicating the acceleration and the angular velocity thus sensed. In this embodiment, each of the sensor units 53 is embodied using an inertial measurement unit (IMU), which is a device that is capable of measuring a moving state of an object and that is widely used in various fields such as aviation, nautical, robots, drones, etc.

It is worth noting that, the details in which the IMU measures the moving state of an object may be readily obtained by a person with ordinary knowledge of the related art based on the above description, and details thereof are omitted herein for the sake of brevity.

Each of the distal battery units 54 (e.g., a rechargeable battery) is for providing electrical energy for a corresponding one of the distal communication units 52 and a corresponding one of the processing units 55, and is capable of receiving electrical energy through electromagnetic induction and storing electrical energy therein.

Each of the processing units 55 is electrically connected to a corresponding one of the distal communication units 52, a corresponding one of the sensor units 53 and a corresponding one of distal battery units 54. Each of the processing units 55 is for receiving the acceleration data (D1) and the angular velocity data (D2), and is for transmitting, via the corresponding one of the distal communication units 52, a wireless signal (S) that includes a received signal strength indicator (RSSI), the acceleration data (D1), the angular velocity data (D2) or a combination thereof to the proximal communication unit 42 of the electric vehicle 4.

Each of the carrying units 56 is disposed in the sole 512 of a corresponding one of the main objects 51, and is for encapsulating the corresponding one of the distal communication units 52, the corresponding one of the sensor units 53, the corresponding one of distal battery units 54, and the corresponding one of the processing units 55 therein.

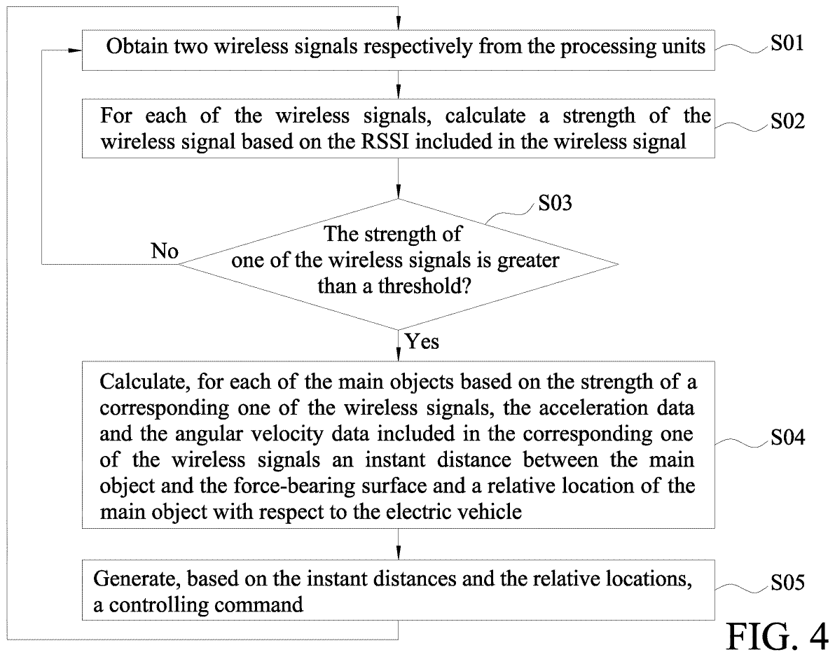

Referring to FIGS. 3 and 4, a controlling method of the electric vehicle 4 according to an embodiment of the disclosure includes the following steps implemented by the electrical control unit 45:
Step S01: obtaining, through the proximal communication unit 42, the two wireless signals (S) respectively from the processing units 55.
Step S02: for each of the wireless signals (S), calculating a strength of the wireless signal (S) based on the RSSI included in the wireless signal (S).
Step S03: Determining whether the strength of one of the wireless signals S is greater than a threshold. When the determination is affirmative, the flow proceeds to the next step. Otherwise, the flow goes back to step S01.

It is worth noting that the proximal communication unit 42 is paired with the distal communication units 52 in advance. In the case that the strength of one of the wireless signals (S) is larger than the threshold, it may signify that at least one of the main objects 51 is in immediate proximity to the force-bearing surface 411. In practice, such a case may be seen as at least one foot of a user wearing at least one of the main objects 51 is directly in contact with the force-bearing surface 411 of the electric vehicle 4 (e.g., the user is standing on the force-bearing surface 411 of the electric vehicle 4).
Step S04: calculating for each of the main objects 51, based on the strength of a corresponding one of the wireless signals (S), the acceleration data (D1) and the angular velocity data (D2) included in the corresponding one of the wireless signals (S), an instant distance between the main object 51 and the force-bearing surface 411 and a relative location of the main object 51 with respect to the electric vehicle 4, resulting in two instant distances and two relative locations respectively for the main objects 51.
Step S05: generating, based on the instant distances and the relative locations, a controlling command.

The controlling command is configured to unlock the electric vehicle 4, lock the electric vehicle 4, activate the light component 412 of the electric vehicle 4, or activate the electric machine 413 of the electric vehicle 4.

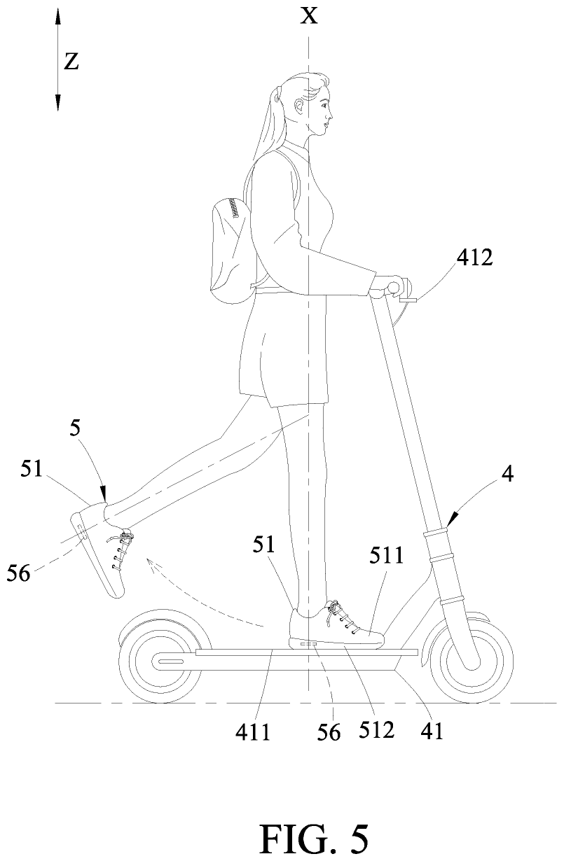

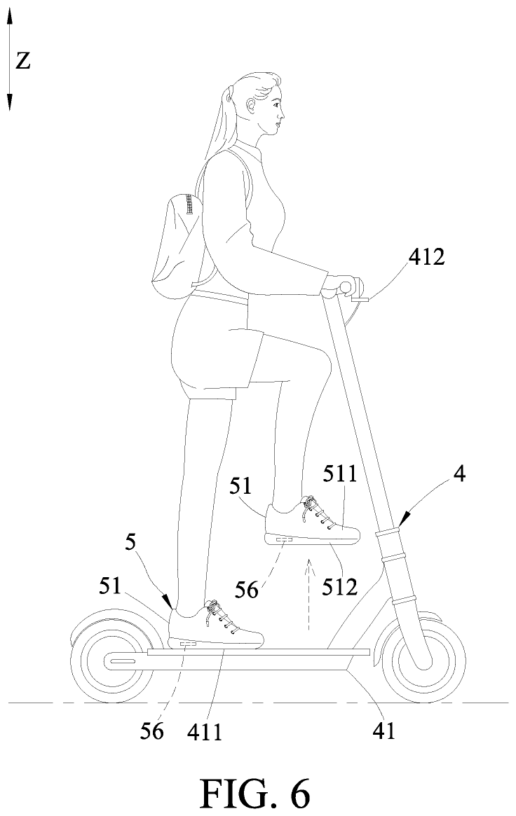

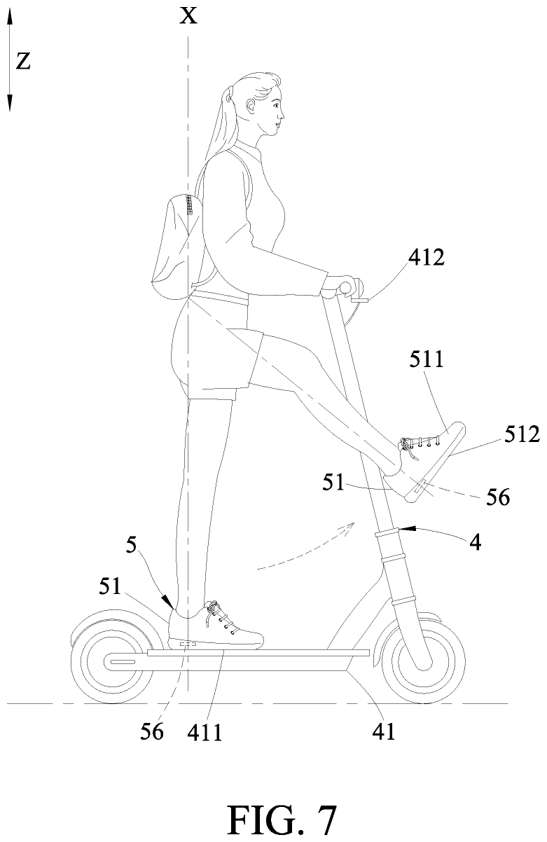

Referring to FIGS. 2, 5, 6 and 7, in some examples, the main objects 51 may move with respect to the force-bearing surface 411, and a state of the main objects 51 may be defined as in one of a first mode (as shown in FIG. 2), a second mode (as shown in FIG. 5), a third mode (as shown in FIG. 6) and a fourth mode (as shown in FIG. 7).

When the electrical control unit 45 determines that, based on the instant distances and the relative locations, the main objects 51 are in the first mode where the main objects 51 are coplanar and the instant distances are substantially the same (indicating the user is standing on the force-bearing surface 411 with both feet), the electrical control unit 45 is configured to generate the controlling command to unlock the electric vehicle 4.

When the electrical control unit 45 determines that, based on the instant distances and the relative locations, the main objects 51 are in the second mode where one of the main objects 51 is in immediate proximity to the force-bearing surface 411 and is in a stationary state, and the other one of the main objects 51 is subjected to a swinging action with respect to an imaginary axis (X) within 90 degrees of a first direction (e.g., the clockwise direction), which means that the user is swinging one leg backward, the electrical control unit 45 is configured to generate the controlling command to activate the electric machine 413 of the electric vehicle 4. The imaginary axis (X) is parallel to an up-down direction (Z) and extends through the carrying unit 56 disposed in the one of the main objects 51 that is in immediate proximity to the force-bearing surface 411.

When the electrical control unit 45 determines that, based on the instant distances and the relative locations, the main objects 51 are in the third mode where one of the main objects 51 is in immediate proximity to the force-bearing surface 411 and is in a stationary state, and the other one of the main objects 51 is moving along the up-down direction (Z) and is higher than the one of the main objects 51 in the up-down direction (Z), the electrical control unit 45 is configured to generate the controlling command to activate the light component 412 of the electric vehicle 4.

When the electrical control unit 45 determines that, based on the instant distances and the relative locations, the main objects 51 are in the fourth mode where one of the main objects 51 is in immediate proximity to the force-bearing surface 411 and is in a stationary state, and the other one of the main objects 51 is subjected to a swinging action with respect to the imaginary axis (X) within 90 degrees of a second direction opposite to the first direction (e.g., the counterclockwise direction), which means that the user is swinging one leg forward, the electrical control unit 45 is configured to generate the controlling command to lock the electric vehicle 4.

It should be noted that, the electrical control unit 45 is not limited to using the instant distances and the relative locations to generate the controlling command. In other variations of this embodiment, the electrical control unit 45 may generate the controlling command based only on the instant distances.

For example, when the electrical control unit 45 determines that the main objects 51 are in an alternative first mode where the instant distances are basically the same (which may be enough to indicate standing on the force-bearing surface 411 on both feet), the electrical control unit 45 is configured to generate the controlling command to unlock the electric vehicle 4.

When the electrical control unit 45 determines that, based on the instant distances, the main objects 51 are in an alternative second mode where one of the main objects 51 is in immediate proximity to the force-bearing surface 411 and is in a stationary state, and the other one of the main objects 51 is spaced apart from the force-bearing surface 411 by a first distance, the electrical control unit 45 is configured to generate the controlling command to activate the electric machine 413 of the electric vehicle 4.

When the electrical control unit 45 determines that, based on the instant distances, the main objects 51 are in an alternative third mode where one of the main objects 51 is in immediate proximity to the force-bearing surface 411 and is in a stationary state, and the other one of the main objects 51 is spaced apart from the force-bearing surface 411 by a second distance that is smaller than the first distance, the electrical control unit 45 is configured to generate the controlling command to lock the electric vehicle 4.

It is worth noting that the main objects 51 are not limited to the four modes as described above, and in variations of this embodiment, three modes may be defined, or alternatively five or more modes may be defined. The controlling command is not limited to control the electric vehicle 4 to implement operations of unlocking the electric vehicle 4, locking the electric vehicle 4, activating the light component 412 of the electric vehicle 4, and activating the electric machine 413 of the electric vehicle 4. In variations of this embodiment, other operations for controlling the electric vehicle 4 may be implemented.

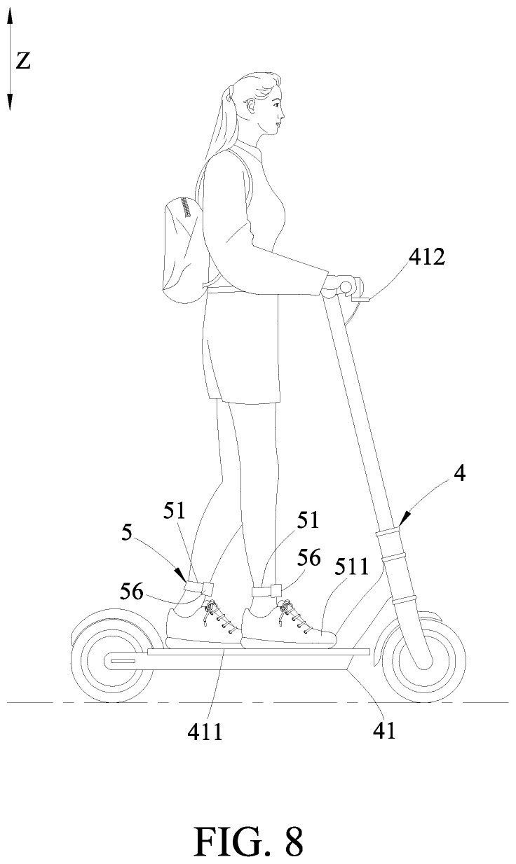

Additionally, the main objects 51 are not limited to the form of a pair of shoes. In one example shown in FIG. 8, the main objects 51 are embodied using a pair of ankle bands. In variations of this embodiment, the main objects 51 are embodied using a pair of wrist bands or other wearable devices.

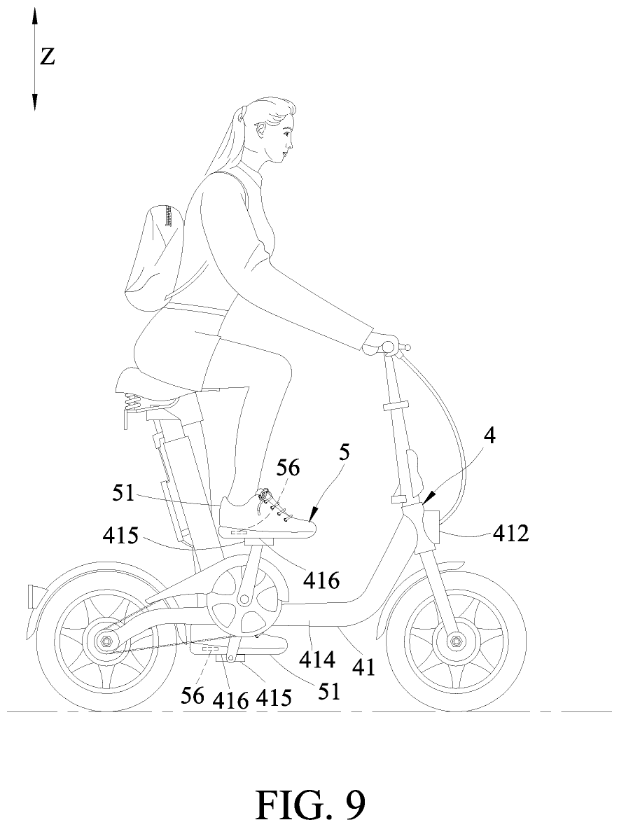

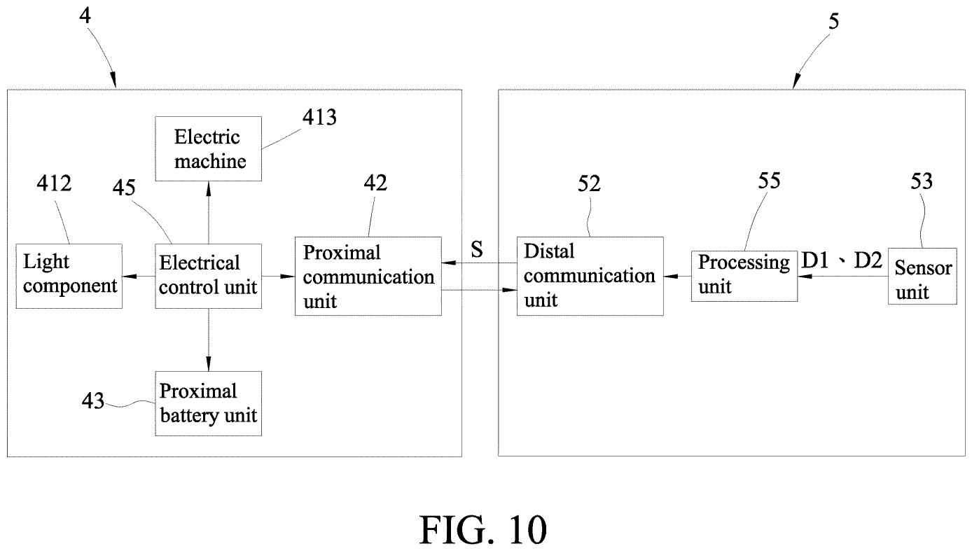

Referring to FIGS. 9 and 10, a second embodiment of an electric vehicle 4 and a controlling device 5 is provided. The second embodiment differs from the first embodiment in the following.

The electric vehicle 4 is not limited to being an electric scooter, and may be embodied using an electric bicycle, a pedelec, an electric motorcycle, etc. In this embodiment, the electric vehicle 4 is embodied using an electric bicycle, and includes at least one proximal communication unit 42.

The vehicle frame unit 41 includes a vehicle body 414, and two pedals 415 that are rotatably connected to the vehicle body 414 and that can be pushed by the two feet of a user. Each of the pedals 415 has a force-bearing surface 416. It is noted that while FIG. 10 only depicts one proximal communication unit 42, in embodiments, two proximal communication units 42 may be present.

Each of the proximal communication units 42 is installed on a corresponding one of the pedals 415, in proximity to the force-bearing surface 416 thereof. In this embodiment, each of the proximal communication units 42 is configured to communicate with the electrical control unit 45 using a wireless communication technique or a wired communication technique.

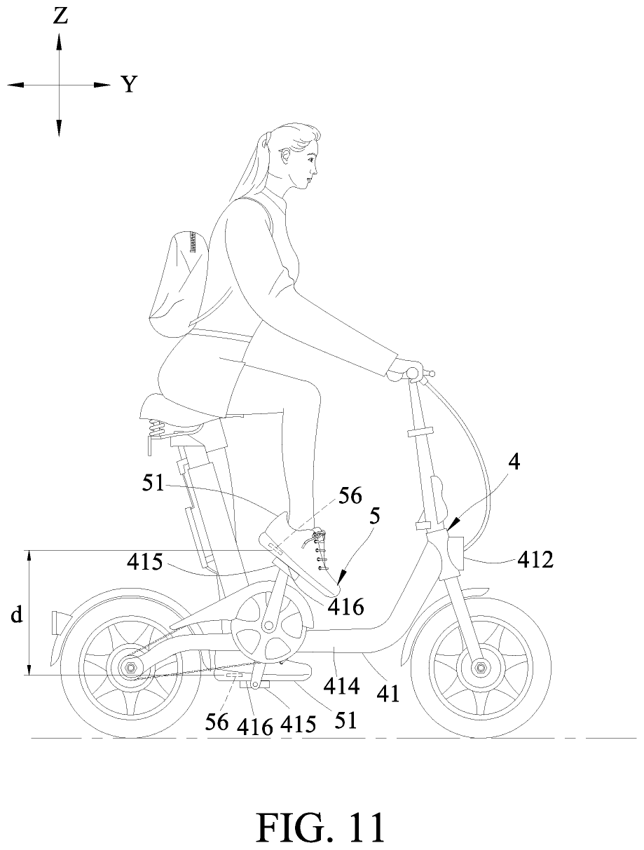

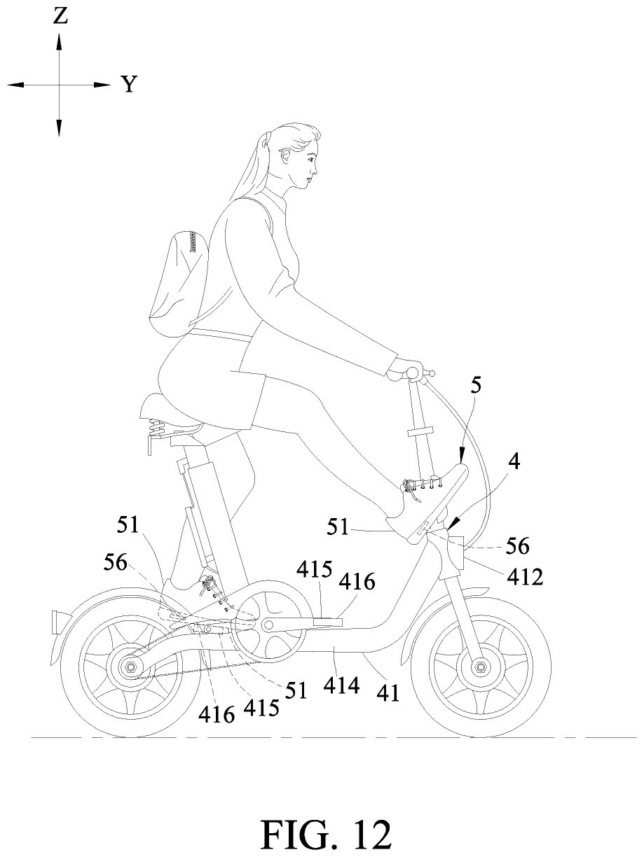

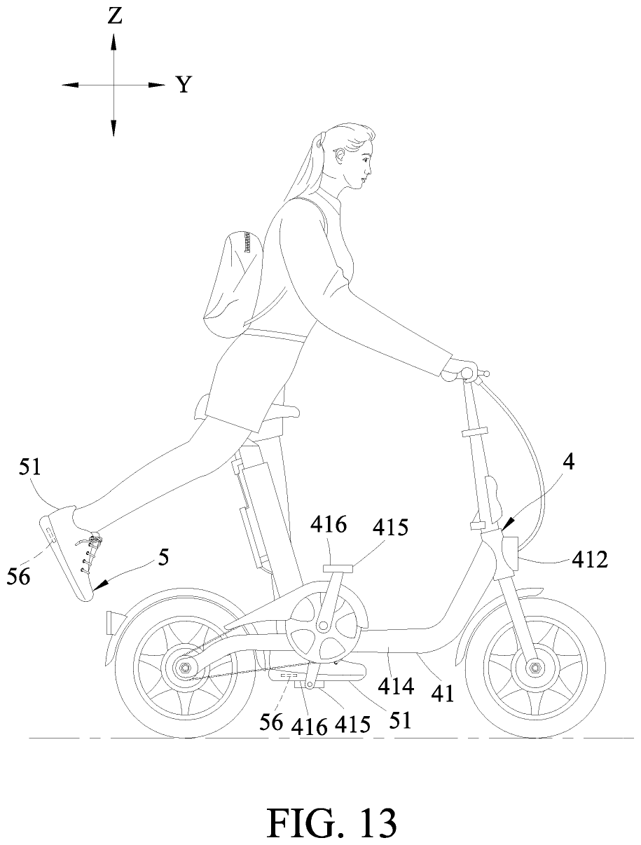

Referring to FIGS. 9 to 13, each of the main objects 51 may move with respect to the force-bearing surface 416 of a corresponding one of the pedals 415, and a state of the main objects 51 may also be defined as in one of a first mode (as shown in FIG. 9), a second mode (as shown in FIG. 11), a third mode (as shown in FIG. 12) and a fourth mode (as shown in FIG. 13).

When the electrical control unit 45 determines that, based on the instant distances and the relative locations, the main objects 51 are in the first mode where the main objects 51 are respectively on the pedals 415 and the instant distances are basically the same (indicating both feet of the user placed on the force-bearing surface 416), the electrical control unit 45 is configured to generate the controlling command activate the light component 412 of the electric vehicle 4.

When the electrical control unit 45 determines that, based on the instant distances and the relative locations, the carrying unit 56 of the main objects 51 are in the second mode where the main objects 51 are in immediate proximity to the force-bearing surfaces 416 on the pedals 415 and are spaced apart from each other by a distance (d) in the up-down direction (Z), and one of the main objects 51 is in a tilted position (i.e., as if the user in on tiptoe on one foot), the electrical control unit 45 is configured to generate the controlling command to activate the electric machine 413 of the electric vehicle 4.

When the electrical control unit 45 determines that, based on the instant distances and the relative locations, the main objects 51 are in the third mode where one of the main objects 51 is in immediate proximity to the corresponding one of the force-bearing surfaces 416 on the corresponding one of the pedals 415, and the other one of the main objects 51 is in front of each of the force-bearing surfaces 416, the electrical control unit 45 is configured to generate the controlling command to unlock the electric vehicle 4.

When the electrical control unit 45 determines that, based on the instant distances and the relative locations, the main objects 51 are in the fourth mode where one of the main objects 51 is in immediate proximity to the corresponding one of the force-bearing surfaces 416 on the corresponding one of the pedals 415, and the other one of the main objects 51 is behind each of the force-bearing surfaces 416 (i.e., the leg of the user swinging backwards), the electrical control unit 45 is configured to generate a controlling command to lock the electric vehicle 4.

Based on the description above, the advantages of the embodiments above may be summarized as below:

The disclosure is configured to detect the instant distances of the main objects 51 and the parts of the electric vehicle 4, and based on the changes of the instant distances, to control the electric vehicle 4 to implement a number of different operations. This provides improved control of the electric vehicle 4 in regards to adaptability, convenience and simplicity.

The disclosure is to control the electric vehicle 4 to implement different operations based on relatively simple movements of the user wearing the main objects 51. In controlling the electric vehicle 4, the user is not required to look at the components of the electric vehicle 4 such as a switch or a display. This provides a more safe manner to control the electric vehicle 4.

The main objects 51 may be embodied using a pair of shoes, which is a necessary accessory for people going outside and using the electric vehicle 4. By using the shoes as the main objects 51, the control of the electric vehicle 4 may be done without using another electronic device such as a smartphone.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A controlling method for controlling an electric vehicle, the controlling method being implemented using an electrical control unit and comprising:
a) obtaining two wireless signals, each of the wireless signals including a received signal strength indicator (RSSI) and one of acceleration data and angular velocity data, and being received from a main object that is in proximity to the electric vehicle and that is not a part of the electric vehicle, the acceleration data indicating acceleration of the main object, the angular velocity data indicating angular velocity of the main object;
b) calculating, for each of the wireless signals, a strength of the wireless signal based on the RSSI included in the wireless signal, and, for each of the main objects, calculating an instant distance between the main object and the electric vehicle based on the strength of a corresponding one of the wireless signals, and a relative location of the main object with respect to the electric vehicle based on the one of the acceleration data and the angular velocity data included in the corresponding one of the wireless signals, so as to determine a state of the main objects being in one of a first mode, a second mode, a third mode and a fourth mode, wherein in the first mode, the main objects are coplanar and the instant distances respectively for the main objects are substantially the same, in the second mode, one of the main objects is in a stationary state and another one of the main objects is subjected to a swinging action with respect to an imaginary axis within 90 degrees of a first direction, the imaginary axis is parallel to an up-down direction and extends through the one of the main objects, in the third mode, one of the main objects is in a stationary state and another one of the main objects is moving along the up-down direction and is higher than the one of the main objects in the up-down direction, in the fourth mode, one of the main objects is in a stationary state and another one of the main objects is subjected to a swinging action with respect to the imaginary axis within 90 degrees of a second direction opposite to the first direction; and
c) generating, based on the instant distance and the relative location for each of the main objects, a controlling command that controls the electric vehicle to implement one of an operation of unlocking the electric vehicle, an operation of locking the electric vehicle, an operation of activating a light component of the electric vehicle, and an operation of activating an electric machine of the electric vehicle.

2. The controlling method as claimed in claim 1, wherein:
in step a), each of the wireless signals includes the acceleration data, the angular velocity data or a combination thereof;
in step b), the relative location of the main object with respect to the electric vehicle is calculated based on the acceleration data, the angular velocity data or the combination thereof.

3. A controlling device for controlling an electric vehicle, the controlling device being electrically connected to an electrical control unit of the electric vehicle and comprising:
two main objects that are wearable on a human body;
two distal communication units installed on the main objects, respectively, each of the distal communication units transmitting a wireless signal to the electrical control unit, the wireless signal including a received signal strength indicator (RSSI) and one of acceleration data and angular velocity data;
two sensor units installed on the main objects, respectively, each of the sensor units being configured to sense acceleration of a corresponding one of the main objects that moves with respect to the electrical vehicle for outputting the acceleration data or to sense angular velocity of the corresponding one of the main objects that moves with respect to the electrical vehicle for outputting the angular velocity data; and
two processing units installed on the main objects, respectively, each of the processing units being electrically connected to a corresponding one of the distal communication units and a corresponding one of the sensor units, each of the processing units being configured to receive the one of the acceleration data and the angular velocity data, and transmit the wireless signal to the electrical control unit via the corresponding one of the distal communication unit, such that the electrical control unit implements the controlling method as claimed in claim 1.

4. The controlling device as claimed in claim 3, wherein:
each of the distal communication unit is configured to communicate with the control device using wireless communication techniques such as Bluetooth®, Wi-Fi, ZigBee, radio frequency ID (RFID); and
each of the sensor units is embodied using an inertial measurement unit (IMU).

5. The controlling device as claimed in claim 3, further comprising two distal battery units installed on the main objects, respectively, each of the distal battery units providing electrical energy for a corresponding one of the distal communication units and a corresponding one of the processing units, and being capable of receiving electrical energy through electromagnetic induction and storing electrical energy therein.

6. The controlling device as claimed in claim 3, wherein the main objects are embodied using one of a pair of wrist bands, a pair of ankle bands, and a pair of shoes.

7. An electric vehicle that is controlled by a controlling device as claimed in claim 3, the electric vehicle comprising:
a vehicle frame unit that is actuated by electrical power;
a proximal communication unit installed on the vehicle frame unit for receiving the wireless signals; and
an electrical control unit installed on the vehicle frame unit, and is electrically connected to the proximal communication unit.

8. The electric vehicle as claimed in claim 7, further comprising a proximal battery unit and a wireless charging unit, the vehicle frame unit including a force-bearing surface configured to bear the main objects which are a pair of shoes, wherein:
the proximal battery unit is installed on the vehicle frame unit, is connected to the electrical control unit, and is for providing electrical power for the vehicle frame unit, the proximal communication unit, the electrical control unit and the wireless charging unit; and
the wireless charging unit is installed on the vehicle frame unit in proximity to the force-bearing surface, and is capable of transferring electrical energy to the controlling device using electromagnetic induction.

9. The electrical vehicle as claimed in claim 7, comprising two proximal communication units, wherein the vehicle frame unit includes a vehicle body, and two pedals that are rotatably connected to the vehicle body and that can be pushed by the two feet of a user, each of the pedals has a force-bearing surface, each of the proximal communication units is installed on a corresponding one of the pedals in proximity to the force-bearing surface thereof, and each of the proximal communication unit is configured to communicate with the electrical control unit using a wireless communication technique or a wired communication technique.
